(19) United States
(12) Patent Application Publication
(10) Pub. No.: US 2002/0138345 A1
(43) Pub. Date: Sep. 26, 2002

(54) Method and system for providing personalized store-issued coupons prior to shopping

(76) Inventors: Bruce Dickson, Apex, NC (US); Mary Louise Dickson, Apex, NC (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/814,350

(22) Filed: Mar. 22, 2001

(51) Int. Cl. G06F 17/60

(52) U.S. Cl. 705/14

(57) ABSTRACT

A method and system for providing personalized coupons at the beginning of a customers shopping process, i.e., before the customer starts to shop. The method includes the steps of obtaining a current shopping list from a wireless communication device (e.g., a PDA, a mobile phone) of the customer, correlating the current shopping list with an available coupon list to identify personalized coupons for the customer, and providing the personalized coupons to the customer at the beginning of the customer's shopping process, so that the coupons can be used effectively during the customer's current store visit.

### BACKGROUND OF THE INVENTION

1. Field of the Invention

The present invention relates to coupon offering systems and, more particularly, to a method and system for providing personalized coupons at the beginning of a customer's shopping process.

2. Discussion of the Related Art

Generally, retail stores such as grocery stores or pharmacies issue coupons to their customers at the time of check-out after the customer renders payment for merchandise. However, since these coupons are issued upon completion of the customer's shopping process, they may not be used until the next time the customer visits the store. In fact, the customer often loses or misplaces the issued coupons after leaving the store so that the coupons may never be used.

In an attempt to address these problems, U.S. Pat. No. 5,918,211 issued to Sloane discloses a method of providing customer discounts, promotions or other information before the customer starts shopping at a retail store. In Sloane, the customer is provided with a portable bar code scanner which is used to scan the bar code on the customer's shopper card. The scanned information is transmitted to the retail store's computer which accesses the customer's purchase history. The retail store's computer then generates and sends a message to the customer's bar code scanner. The message offers customer discounts, promotions or other information based on the purchasing history of the customer.

A significant problem with the Sloane method, however, is that the customer discounts and promotions displayed on the portable bar code scanner are often useless to the customer. This is because the discounts and promotions are offered based on the prior purchase history of the customer, which may differ significantly from the current shopping list of the customer. Another problem with the Sloane method is that the customer must carry the bar code scanner while the customer shops, and must scan appropriate items to take advantage of the discounts and promotions.

Accordingly, a need exists for a method and system for providing discount information or coupons at the beginning of a customer's shopping process, which overcomes the problems encountered in conventional discount-offering systems and which can be used more effectively by the customers without the hassle of carrying bar code scanners or other devices.

### SUMMARY OF THE INVENTION

The present invention is directed to a method and system for providing personalized coupons relevant for a customer's current shopping list at the beginning of the customer's shopping process (i.e., before the customers starts to shop), so that the customer can maximize the use of the coupons while he or she shops.

In one embodiment, when a customer carrying a Personal Digital Assistant (PDA) enters a retail store, the customer approaches a PDA interface located at the front of the store, which initiates short-range wireless communication with the customers PDA according to known techniques such as Bluetooth techniques or infrared communication. The PDA interface retrieves from the customer's PDA a shopping file containing the current shopping list of the customer. The retrieved shopping list is correlated with a list of available coupons in the system to identify coupons that are directly relevant for items specified on the current shopping list. Then the identified coupons are printed and provided to the customer before the customer starts to shop. These coupons are considered “personalized” coupons since they are selected based on the customer's current shopping list.

The present invention provides personalized coupons at the beginning of the customer's shopping process based on the current shopping list of the customer as stored in the customer's PDA. Since the coupons are personalized to match items on the current shopping list of the customer, these coupons are directly relevant for the current shopping list. Thus, the user can take full advantage of these coupons immediately during the current store visit. Moreover, since the coupon selection occurs based on short-range wireless communication between the customer's PDA and the PDA interface, which does not require any interaction with the customer, the customer can receive personalized coupons simply by standing in front of the PDA interface in the store.

### BRIEF DESCRIPTION OF THE DRAWINGS

FIG. 1 is a block diagram of a system for providing personalized coupons at the beginning of a customer's shopping process according to one embodiment of the present invention.

FIG. 2 is a flowchart illustrating the processing steps of a method of providing personalized coupons implementable in the system of FIG. 1 according to one embodiment of the present invention.

FIG. 3 is a block diagram of a system for providing personalized coupons at the beginning of a customer's shopping process according to another embodiment of the present invention.

FIG. 4 is a flowchart illustrating the processing steps of a method of providing personalized coupons implementable in the system of FIG. 3 according to another embodiment of the present invention.

### DETAILED DESCRIPTION OF THE PREFERRED EMBODIMENTS

In the drawings, the same reference numerals are used to indicate the same elements.

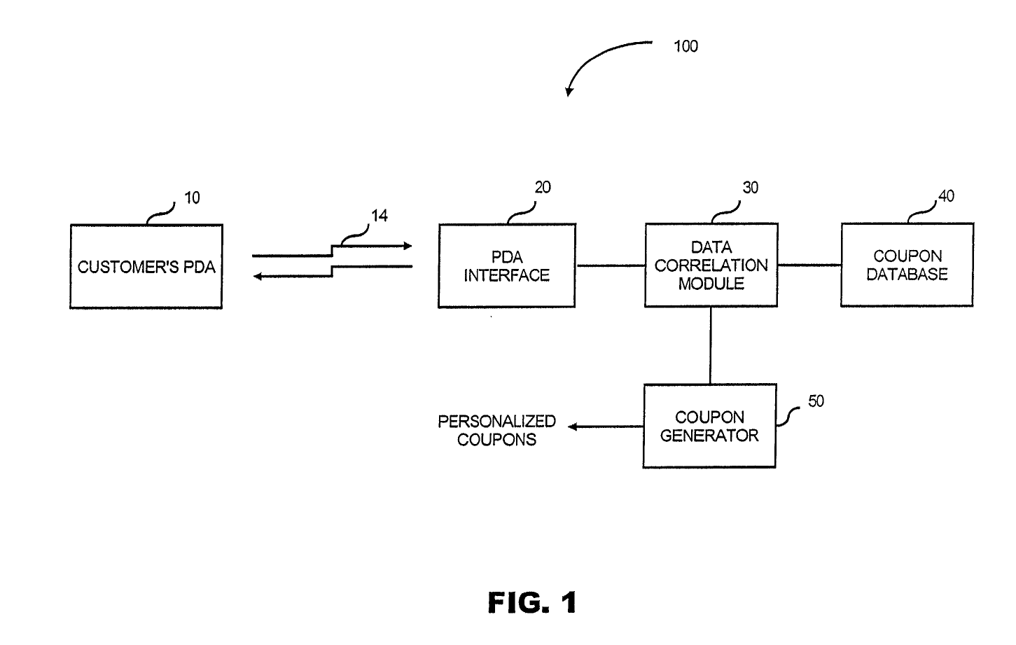

FIG. 1 is a block diagram of a system 100 for providing personalized coupons according to an embodiment of the present invention. As shown in FIG. 1, the system 100 includes a PDA (Personal Digital Assistant) interface 20, a data correlation module 30, a coupon database 40, and a coupon generator 50, all operatively coupled. The system 100 can be implemented at a retail store such as a grocery store, a pharmacy, a video rental store, etc. In a preferred embodiment, at least the PDA interface 20 and the coupon generator 50 are located at the front of the retail store so that coupons can be provided to customers at the beginning of their shopping process, i.e., before they start shopping.

The PDA interface 20 is capable of communicating with a PDA 10 carried by a customer. The PDA 10 is a conventional PDA capable of short-range wireless communication 14 with the PDA interface 20 according to known techniques such as “Bluetooth” techniques. Bluetooth techniques involve providing a small, inexpensive radio unit into mobile devices such as PDAs, mobile phones, PCs. Since the “Bluetooth” radio unit is designed according to a predetermined standard, it allows mobile devices having the Bluetooth radio units to communicate with each other without the use of cables, wireless networks, connectors, HotSyncs, etc. The Bluetooth standard defines the communication standard between two selected devices and/or multiple selected devices. Further information regarding the Bluetooth standard and technology is available online at the website of http://www.bluetooth.com. Also, U.S. Pat. No. 5,974,238 to Chase, Jr., issued on Oct. 26, 1999, which is herein fully incorporated by reference, describes in detail the operation and components of a conventional PDA.

To provide the short-range wireless communication 14 between the customer's PDA 10 and the PDA interface 20, e.g., using Bluetooth techniques, each of the PDA 10 and the PDA interface 20 includes a Bluetooth radio unit known in the art. A Bluetooth radio unit includes both hardware (e.g., antenna, modulator, etc.) as well as software for implementing the communication 14. When the customer with the PDA 10 comes in a predetermined communication range of the PDA interface 20 and the PDA 10 is turned on, the PDA interface 20 initiates the short-range wireless communication 14 with the PDA 10 through the Bluetooth radio units, and is able to access information or files stored in the PDA 10, such as shopping list files, to-do list files, previous purchase records, product preferences, demographics of the owner of the PDA (name, home address, etc.), etc.

In the present invention, the PDA interface 20 retrieves the customer's current shopping list by accessing certain shopping files or to-do-list files from the PDA 10. The data correlation module 30 correlates this shopping list with a list of coupons available in the system which may be stored in the coupon database 40, and identifies any coupons that will be useful for items specified on the customer's current shopping list. For example, if the current shopping list specifies that a cat food and a toothpaste need to be purchased during the current store visit, the data correlation module 30 searches for any coupon directed to cat foods and toothpastes. If the search results indicate that there are large numbers of coupons from different companies for cat foods and toothpastes, the data correlation module 30 may narrow these numbers using some criteria so that a reasonable number of coupons can be issued per customer.

The coupon selections by the data correlation module 30 are then communicated to the coupon generator 50 which in turn prints the selected coupons to the customer. These coupons are considered “personalized” coupons because they are selected to meet the specific shopping need of each customer based on the current shopping list of the customer as stored in the PDA 10.

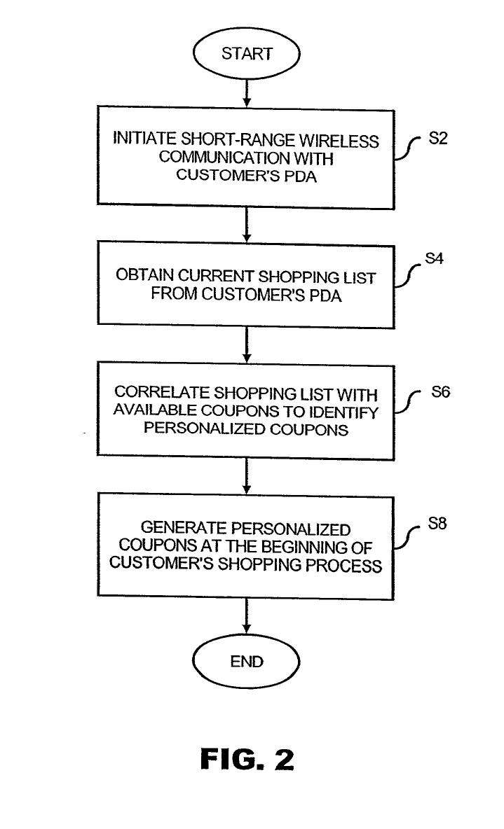

FIG. 2 is a flowchart illustrating the processing steps of a method of providing personalized coupons according to an embodiment of the present invention. These processing steps can be implemented by the system of FIG. 1. As shown in FIG. 2, in Step S2, when a customer carrying a PDA 10 enters a retail store with the PDA 10 turned on, the customer approaches the PDA interface 20 located at the front of the store, which initiates short-range wireless communication 14 with the customer's PDA 10 according to known techniques such as Bluetooth techniques as discussed above. In Step S4, through the short-range communication 14, the PDA interface 20 retrieves from the customer's PDA 10 a shopping file or the like containing the current shopping list of the customer to be used during the current store visit. In Step S6, the retrieved shopping list is correlated with coupon information stored in the coupon database 40. The correlation results indicate one or more “personalized” coupons directly relevant for items that are specified on the current shopping list.

Then in Step S8, the coupon generator 50 generates the identified personalized coupons, e.g, by printing them, and outputs these coupons to the customer at the beginning of the customer's shopping process, i.e., before the customer starts to shop so that the customer can use these coupons during the current shopping process. This completes the method of providing personalized coupons according to the embodiment of the present invention.

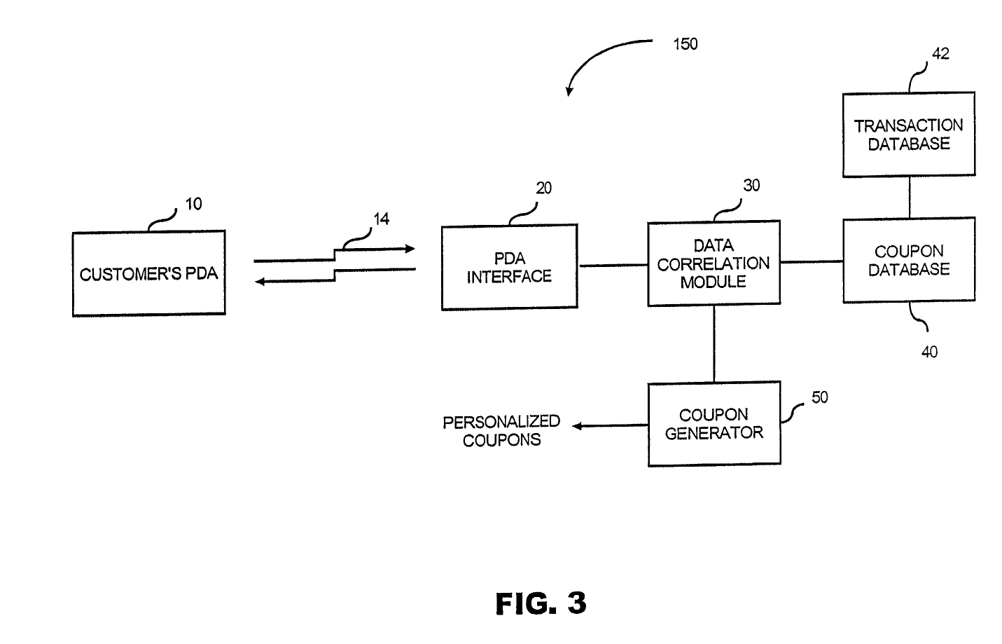

FIG. 3 shows a block diagram of a system 150 for providing personalized coupons at the beginning process of a customer's shopping process according to another embodiment of the present invention. As shown in FIG. 3, the system 150 is identical to the system 100 shown in FIG. 1, except for the addition of a transaction database 42 and its use in the system 150. The transaction database 42 stores transaction information such as purchase records or purchase patterns of different customers of the retail store. The transaction information can be obtained from Point-of-Sale (POS) terminals or check-out registers in the store when the customers use their credit cards or shopper cards (e.g., VIC or affinity cards) since the customer's personal information can be associated with the customer's purchased item information (e.g., brands, price, quantity, etc.).

The data correlation module 30 utilizes the transaction information stored in the transaction database 42 to provide even more personalized coupons than the coupons provided by the system 100 of FIG. 1. For instance, if the current shopping list from the customer's PDA 10 specifies a toothbrush and a soap to be purchased, the data correlation module 30 correlates this shopping list with the coupon information stored in the coupon database 40 to identify a list of coupons relevant for all soaps and toothbrushes. This may identify coupons for different brands of soaps and toothbrushes. Then the data correlation module 30 examines the prior purchase records of the customer stored in the transaction database 42 and determines if any particular brand(s) of toothbrush and/or soap have been purchased by the customer previously. If such correlation results indicate that the customer has purchased previously “Oral-B” toothbrush and “Ivory” soap, for example, the data correlation module 30 compares this information with the identified coupons of different brands of toothbrush and soap to narrow the search into particular brands, such as “Oral-B” toothbrush and “Ivory” soap, and the coupons for “Oral-B” toothbrush and “Ivory” soap are provided to the customer. However, if there are no coupons available in the system for “Oral-B” toothbrush and/or “Ivory” soap, coupons for a certain other brand of toothbrush and/or soap may be selected using some criteria, e.g., brands that are competitively equal to “Oral-B” and “Ivory” brands.

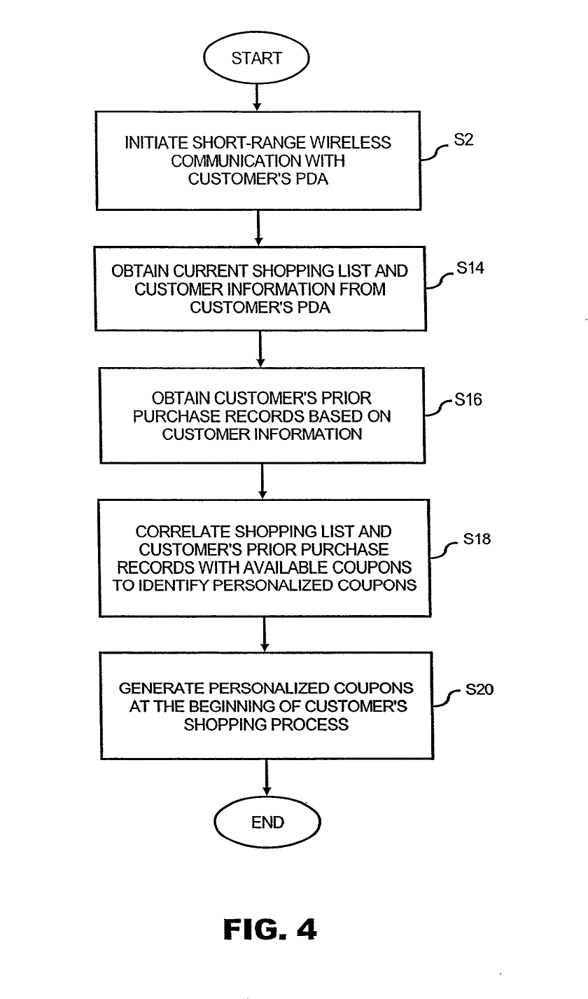

FIG. 4 is a flowchart illustrating the processing steps of a method of providing personalized coupons according to another embodiment of the present invention. These processing steps can be implemented in the system 150 of FIG. 3. As shown in FIG. 4, when a customer carrying a PDA 10 approaches the PDA interface 20 located at the front of the store, the PDA interface 20 initiates short-range wireless communication 14 with the customer's PDA 10 in Step S2 (this step is identical to Step S2 of FIG. 2). In Step S14, the shopping list of the customer for the current store visit as stored in the customer's PDA 10, and the customer's personal information (e.g., name, shopper card number, etc.) are retrieved by the PDA interface 20 from the customer's PDA 10 through the short-range communication 14.

In Step S16, the data correlation module 30 obtains from the transaction database 42 the customer's prior purchase records based on the costumer's personal information obtained from the PDA 10. In Step S18, the customer's current shopping list and prior purchase records are correlated with the coupon information stored in the coupon database 40. This can be accomplished by comparing the current shopping list with the available coupon information to identify coupons for all brands of items specified on the shopping list. The identified brands of items are compared with the particular brands of items that the customer has purchased previously based on the customer's prior purchase records. The comparison results will indicate personalized coupons, not only for the items that the customer is planning to purchase, but for the particular brands of these items that the customer has actually purchased previously. Therefore, more personalized coupons that are directly relevant for the customer's current store visit can be provided.

In Step S20, the identified personalized coupons are generated by the coupon generator 50 and provided to the customer at the beginning of his or her shopping process. This completes the method of providing personalized coupons according to the embodiment of the present invention.

The processing steps of the present invention can be implemented by computer programs in conjunction with hardware components. Software programming code which embodies the present invention may be stored on any of a variety of known media such as a diskette, hard drive, or CD-ROM, and may be distributed on such media. The techniques and methods for embodying software programming code on physical media and/or distributing software code are known in the art.

Although the present invention has been described in connection with using PDAs carried by customers to obtain the customers' shopping lists and/or personal. information, other wireless communication devices that are carried by individuals, such as mobile phones (e.g., cellular phones), two-way pagers, etc., can be used instead as long as they store such information and are capable of short-range wireless communication with an interface such as the interface 20. Furthermore, instead of Bluetooth techniques, other short-range wireless communications can be used between the PDA (or other wireless communication device) and the PDA interface (or appropriate interface). For example, instead of Bluetooth techniques, short-range wireless communication 14 can be infrared communication wherein data is transmitted optically. For instance, certain conventional PDAs, such as Palm III™, are capable of communicating with other PDAs or communication devices using their built-in infrared ports present in the PDAs. Using the built-in infrared communication capability, the PDAs or other wireless communication devices such as mobile phones, can communicate with an interface such as the interface 20 in the store according to the present invention.

In one embodiment, the PDA interface 20 or the like and the coupon generator 50 are located at the front of the retail store, and other components such as the data correlation module 30, the coupon database 40 and/or the transaction database 42 are located remote from the coupon generator 50. In this embodiment, communication between these components may occur according to known remote communication techniques such as via radio waves, cable, fiber optics, wireless communication, etc.

For use with the present invention, the PDA (or other wireless communication device, e.g., a mobile phone, a two-way pager) may be loaded with an application program that stores the owner's shopping list, product preferences, and/or previous purchase records. If the previous purchase records can be stored in the PDA, the data correlation module 30 in the system 150 can access this information from the PDA and not necessarily from the transaction database 42.

According to the present invention, there are a variety of different ways in which the entry of the shopping list and/or preferences into the customer's PDA or other wireless communication device can be implemented, such that the entered information can be recognized by the data correlation module 30. For instance, the store itself can supply a simple program for the customer's PDA or the like. This program would provide a “catalog” listing of items from which the customer can make selections and/or allow the customer to type in the items in plain English. The store system (e.g., data correlation module 30) would read and interpret this list and compare the list contents to the store's catalog of available items. The store system can also be configured to analyze the customer's list in view of synonyms using known computer programs to identify appropriate product descriptions.

A “customer” as discussed in the present application is any person who enters a shopping location which may be a retail store, shopping mall, etc. In fact, the present invention is applicable in any system or location where coupons are offered or can be offered to individuals for discounts, promotions, etc., e.g., department stores, video rental places, retail stores, wholesale stores such as BJ or Sam's, etc.

In one embodiment, the short-range wireless communication between the PDAs (or other communication device) and the PDA interface occurs without realization by the customer carrying the PDA as long as the PDA is turned on and the customer is present in front of the PDA interface or within the predetermined range. It is understood that, to protect the privacy of individuals, the PDA can be configured to communicate with the PDA interface selectively, so that information stored in the PDA may not be accessible automatically by the PDA interface even if the PDA is turned on and the customer is present in front of the PDA interface. This can be accomplished by using security codes, or certificates and keys to enable and disable communication between the PDAs and the PDA interface according to known techniques.

The present invention provides personalized coupons at the beginning of the customer's shopping process, i.e., before the customer starts to shop. As a result, the customer can use these coupons during the current store visit. Furthermore, since the coupons are personalized to be directly relevant for those items specified on the customer's current shopping list, the customer can take full advantage of the personalized coupons immediately. Moreover, since the personalized coupons are printed by the store system, the customer need not shuffle through numerous coupons that the customer has collected from other sources to find coupons that match items on the store shelves. In addition, since the coupon selection occurs based on short-range wireless communication between the customer's PDA and the PDA interface, which does not require any input or action from the customer, the customer can receive the personalized coupons by simply being present near the PDA interface. Therefore, the present invention enhances the shopping experience of the customer significantly, and provides a positive, money-saving, efficient shopping experience to the customers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for providing personalized coupons to a customer at the beginning of the customer's shopping process, the method comprising the steps of:
obtaining a current shopping list from a wireless communication device of the customer;
correlating the current shopping list with an available coupon list to identify personalized coupons for the customer; and
providing the personalized coupons to the customer at the beginning of the customer's shopping process.

2. The method of claim 1, wherein the correlating step includes:
comparing items identified in the current shopping list with the available coupon list; and
designating coupons directly relevant for said items as the personalized coupons if the comparison results indicate at least one match.

3. The method of claim 2, further comprising:
designating coupons related to said items as the personalized coupons if the comparison results indicate no match.

4. The method of claim 1, wherein the wireless communication device is a personal digital assistant, a mobile phone, or a two-way pager carried by the customer.

5. The method of claim 1, wherein, in the obtaining step, the current shopping list is obtained from the customer's wireless communication device using Bluetooth techniques or infrared communication techniques.

6. The method of claim 1, further comprising:
obtaining customer information from the wireless communication device;
obtaining previous purchase records of the customer based on the customer information.

7. The method of claim 6, wherein the correlating step correlates the current shopping list and the previous purchase records with the available coupon list to identify the personalized coupons.

8. The method of claim 6, further comprising:
pre-storing purchase records of a plurality of customers using Point-of-Sale (POS) terminals.

9. A system for providing personalized coupons to a customer at the beginning of the customer's shopping process, the system comprising:
an interface for obtaining a current shopping list from a wireless communication device of the customer;
a correlation module for correlating the current shopping list with an available coupon list to identify personalized coupons for the customer; and
a coupon generator for generating the personalized coupons to the customer at the beginning of the customer's shopping process.

10. The system of claim 9, wherein the correlation module compares items identified in the current shopping list with the available coupon list, and designates coupons directly relevant for said items as the personalized coupons if the comparison results indicate at least one match.

11. The system of claim 10, wherein the correlation module designates coupons related to said items as the personalized coupons if the comparison results indicate no match.

12. The system of claim 9, wherein the wireless communication device is a personal digital assistant, a mobile phone, or a two-way pager carried by the customer.

13. The system of claim 9, wherein the current shopping list is obtained from the customer's wireless communication device using Bluetooth techniques or infrared communication techniques.

14. The system of claim 9, further comprising:
a first database for storing the available coupon list; and
a second database for storing purchase records of a plurality of shoppers in the system.

15. The system of claim 14, wherein the interface further obtains customer information from the wireless communication device of the customer, and the correlation module obtains, from the second database, previous purchase records of the customer based on the obtained customer information.

16. The system of claim 15, wherein the correlation module correlates the current shopping list and the obtained customer's previous purchase records with the available coupon list to identify the personalized coupons.

17. The system of claim 14, wherein the interface and the coupon generator are located at a front location of a store.

18. The system of claim 18, wherein at least one of the correlation module, the first database and the second database is located remote from said front location of the store.

19. A computer program product embodied on computer readable media readable by a computing system in a computing environment, for providing personalized coupons to a customer at the beginning of the customer's shopping process, the computer program product comprising:
first computer-readable program code means for obtaining a current shopping list from a wireless communication device of the customer;
second computer-readable program code means for correlating the current shopping list with an available coupon list to identify personalized coupons for the customer; and third computer-readable program code means for providing the personalized coupons to the customer at the beginning of the customer's shopping process.

20. The computer program product of claim 19, wherein the second computer-readable program code means compares items identified in the current shopping list with the available coupon list, and designates coupons directly relevant for said items as the personalized coupons if the comparison results indicate at least one match.

21. The computer program product of claim 20, wherein the second computer-readable program code means designates coupons related to said items as the personalized coupons if the comparison results indicate no match.

22. The computer program product of claim 19, wherein the wireless communication device is a personal digital assistant, a mobile phone, or a two-way pager carried by the customer.

23. The computer program product of claim 19, wherein the first computer-readable program code means obtains the current shopping list from the customer's wireless communication device using Bluetooth techniques or infrared communication techniques.

24. The computer program product of claim 19, further comprising:
fourth computer-readable program code means for obtaining customer information from the wireless communication device;
fifth computer-readable program code means for obtaining previous purchase records of the customer based on the customer information.

25. The computer program product of claim 25, wherein the second computer-readable program code means correlates the current shopping list and the previous purchase records of the customer with the available coupons to identify the personalized coupons.
